(19) United States
(12) Patent Application Publication
(10) Pub. No.: US 2026/0078239 A1
(43) Pub. Date: Mar. 19, 2026

(54) USE OF AN ANTIOXIDANT FOR REDUCING AND/OR PREVENTING THE TOXICITY OF A RUBBER COMPOSITION

(71) Applicant: NYCO, Paris (FR)

(72) Inventors: Florence SEVERAC, Gargenville (FR); Grégoire HERVE, Paris (FR)

(21) Appl. No.: 18/857,650

(22) PCT Filed: Apr. 26, 2023
(86) PCT No.: PCT/EP2023/061024

§ 371 Date: Oct. 17, 2024

(30) Foreign Application Priority Data
Apr. 27, 2022 (FR) FR2203941

(51) Int. Cl. C08K 5/18

(52) U.S. Cl. CPC C08K 5/18; C08K 2201/019

(57) ABSTRACT

The present invention relates to the use of at least one antioxidant in a rubber composition, said at least one antioxidant comprising at least one oligomer and/or polymer having at least one diphenylamine repeat unit for reducing and/or preventing the toxicity of said rubber composition.

This application is the U.S. national phase of International Application No. PCT/EP2023/061024 filed Apr. 26, 2023, which designated the U.S. and claims priority to FR2203941 filed Apr. 27, 2022, the entire contents of each of which are hereby incorporated by reference.

### TECHNICAL FIELD

The present invention relates to the field of antioxidant additives used in rubber compositions, namely in elastomer compositions (natural or synthetic macromolecular substance, having rubber elasticity). The present invention particularly relates to the use of specific polymeric antioxidants in a rubber composition in order to reduce and/or prevent its toxicity.

### TECHNOLOGICAL BACKGROUND

The applications of rubber compositions cover a wide range of uses in everyday life, such as seals, pipes, in the automotive industry (tires, seat belt and various rubber parts: hoses, etc.), medical field, clothing sector (shoe sole) and also in high performance uses (aeronautical and offshore).

In a known manner, rubber compositions generally comprise one or more additives including antioxidants.

Antioxidants are also used in a wide range of applications and everyday objects, and despite of their relatively small content in the material in which they are incorporated, their supply is crucial to the lifespan and preservation of the physicochemical and mechanical properties of these everyday objects. In the particular case of plastics, or more specific, of rubbers used in pipes (under-the-hood parts for example), electric cables or tires, their presence allows for the preservation of mechanical properties of the materials by avoiding, in particular, their hardening by oxidation in the air or by ozone (as in the case of tires subject to the action of ozone generated by the heating of the air in contact with catalytic converters related to road traffic).

To date, aromatic amines, such as diphenylamine monomers (DPA) or p-phenylenediamines (PPD), are very widely used in rubber pipes, cables or tires. This last family (PPD) is now a range of additives of choice for its antioxidant and antiozonant properties, which are necessary for tires subjected to these two ageing phenomena. As an example, the compound N,N′-Bis(1,4-dimethylpentyl)-p-phenylenediamine (hereafter 77PD, CAS 3081-14-9) is commonly used for the rubber coatings of electric cables. It is also estimated that in 2009, 100 000 tons per year of N-(1,3-dimethylbutyl)-N′-phenyl-p-phenylenediamine (hereafter 6PPD) were consumed in China in the manufacture of rubber for all applications.

Unfortunately, recent studies show that the toxicological profile of standard antioxidants, like those based on aromatic amines or diamines, is changing for the worse, and in a drastic and worrying way with regard to the established dangers for humans and their environment (carcinogenicity, mutagenicity or reproductive toxicity, known as “CMR”, aquatic toxicity/ecotoxic, bioaccumulation, substance classified as Persistent, Bioaccumulative and Toxic, known as “PBT”). This trend is accelerating under the influence of international regulatory agencies urging for increasingly precise and intensive characterization of chemical materials produced in very large volumes. As an example, European Chemicals Agency (ECHA) reports on the clear dangers of the main antioxidants, particularly those belonging to the family of diphenylamine (DPA) or p-phenylenediamine (PPD) monomers used extensively in the chemical industry of fluids, plastics or rubber.

In particular, standard antioxidants as well as their confirmed toxicity(ies) are listed in the Table 1 below:

TABLE 1

| Compound | Denomination | CAS No | Toxicity |
|---|---|---|---|
| N-(1,3- | 6PPD | CAS 793-24-8 | Harms fertility or has a negative impact |
| dimethylbutyl)-N′- | | | on the unborn child (reprotoxic), toxic |
| phenyl-p- | | | for the aquatic life with long-term |
| phenylenediamine | | | effects (ecotoxic), is harmful if ingested |
| | | | (acute toxicity) and may cause an |
| | | | allergic skin reaction |
| | | | (https://echa.europa.eu/fr/substance- |
| | | | information/-/substanceinfo/100.011.222) |
| N′-isopropyl-N′- | IPPD | CAS 101-72-4 | Is very harmful to aquatic life with long- |
| phenyl-p- | | | term effects (ecotoxic), is harmful if |
| phenylenediamine | | | swallowed (acute toxicity) and may |
| | | | further cause an allergic skin reaction |
| | | | (https://echa.europa.eu/fr/substance- |
| | | | information/-/substanceinfo/100.002.700 |
| N-cyclohexyl-N′- | CPPD | CAS 101-87-1 | Is toxic to aquatic life with long-term |
| phenyl-p- | | | effects (ecotoxic), and may further |
| phenylenediamine | | | cause an allergic skin reaction |
| | | | (https://echa.europa.eu/fr/substance- |
| | | | information/-/substanceinfo/100.002.714 |
| N,N′-diphenyl-p- | DPPD | CAS 74-31-7 | Is harmful to aquatic life with long-term |
| phenylenediamine | | | effects (ecotoxic), and may further |
| | | | cause an allergic skin reaction |
| | | | (https://echa.europa.eu/fr/substance- |
| | | | information/-/substanceinfo/100.000.734 |
| N,N′-Bis(1,4- | 77PD | CAS 3081-14-9 | Is very toxic to aquatic life with long- |
| dimethylpentyl)-p- | | | term effects (ecotoxic), is harmful if |
| phenylenediamine | | | swallowed (acute toxicity) and may |
| | | | further cause an allergic skin reaction |
| | | | (https://echa.europa.eu/fr/substance- |
| | | | information/-/substanceinfo/100.019.433 |
| N,N-diphenylamine | Irganox ® | CAS 68411-46-1 | Is harmful to aquatic life with long-term |
| monomer mixture | L57 | | effects (ecotoxic) |
| | | | (https://echa.europa.eu/fr/substance- |
| | | | information/-/substanceinfo/100.063.733 |
| Bis(nonylphenyl)amine | Irganox ® | CAS 36878-20-3 | Is harmful to aquatic life with long-term |
| | L67 | | effects (ecotoxic) |
| | | | (https://echa.europa.eu/fr/substance- |
| | | | information/-/substanceinfo/100.048.393 |
| N-phenyl-1- | PAN-1 | CAS 90-30-2 | Is very toxic to aquatic life with long- |
| naphthylamine | | | term effects (ecotoxic), is harmful if |
| | | | swallowed (acute toxicity), can cause |
| | | | organ damage through prolonged or |
| | | | repeated exposure and may further |
| | | | cause an allergic skin reaction |
| | | | (https://echa.europa.eu/fr/substance- |
| | | | information/-/substanceinfo/100.001.803 |
| 4,4′-methylene-bis- | Ethanox ® | CAS 118-82-1 | Under evaluation as an endocrine |
| (2,6-di- | 4702 | | disruptor and persistent, |
| tertbutylphenol) | or | | bioaccumulative and toxic substance |
| | MEDBP | | (PBT substance) |
| | | | (https://echa.europa.eu/fr/substance- |
| | | | information/-/substanceinfo/100.003.891 |

This standard antioxidant toxicity was in particular confirmed by recent scientific research, such as those of Tian et al., Science, 2021, 371 (6525), 185-189 or those of W. Huang et al., Environ. Sci. Technol. Lett. 2021, 8, 381-385, which show that the main antioxidants used to date are toxic to humans and/or environment.

The publication of Tian et al. focuses on the effect of antioxidants on the Pacific coho salmon (Oncorhynchus kisutch) (Northeastern US). The authors found that in this salmon, annual exposure to rainwater leads to unexplained acute mortality when adult salmon migrates to urban streams in order to reproduce. By studying this phenomenon, they identified in waters a highly toxic transformation product of 6PPD, the 6PPD-quinone. As mentioned above, 6PPD is an antioxidant of the tire rubber omnipresent in the world. Therefore, this study shows that the oxidation products derived from 6PPD are even more toxic than the 6PPD itself. In particular, retrospective analysis of runoff from roadways and stormwater streams representative of the west coast of the United States revealed the widespread presence of 6PPD-quinone (<0.3 to 19 micrograms per liter) in toxic concentrations (median lethal concentration of 0.8±0.16 microgram per liter). This publication thereby shows that the compound 6PPD and its oxidation products are highly ecotoxic and the rubber residues from tires scattered in nature are a real ecological challenge.

The publication of W. Huang et al. also demonstrated that tire wear particles containing these toxic antioxidants are widespread throughout the environment, namely on the roads, car parks and even inside the cars and houses. These antioxidants include 6PPD, IPPD, CPPD or DPPD. In particular, the 6PPD-quinone has been detected inside motor vehicles.

A publication of Zhang et al., Environ. Sci. Technol. 2021 («p-Phenylenediamine Antioxidants in PM2.5: The Underestimated Urban Air pollutants”) on air quality in China's major cities showed significant traces of antioxidants commonly used in rubber compositions, in fine particles of the urban atmospheric air, such as the compounds 6PPD and 77PD, as well as oxidation products IPPD-quinone and DPPD-quinone.

FR 2 156 392 discloses antioxidant products for materials such as rubber (page 6, line 1-4) like 2-(4,4′-di-t-octyldiphenylamino)-4,4′-di-t-octyl diphenylamine. This document only quotes in general rubbers, in the same way as plastics, without ever substantiating their description, as well as the effectiveness of antioxidants in such compositions which are, unlike lubricant compositions, in solid state. Only performance in the field of fluids and lubricants is demonstrated.

CN 107 540 559 discloses a method for preparing 4,4′-bis(α,α-dimethylbenzyl)diphenylamine. According to that document (paragraph 0031), it would have a non-toxic effect. However, no experimental tests illustrate this property in this document. No methodology showing its non-toxicity was described or suggested. The inventors cited only the benefits of this compound in a very subjective way. Even its effectiveness has not been demonstrated. On the contrary, the Applicant demonstrated that this compound is highly toxic, whether in terms of reprotoxicity, mutagenicity and carcinogenicity (cf. compound 25 in Table 5 below).

EP 2 842 995 relates to a specific material for manufacturing a special run-flat tire rubber for a wheeled military combat vehicle. To the knowledge of the Applicant, the rubber industry uses only monomer compounds (substances) as antioxidant and not polymers/oligomers.

WO 2009/071857 relates to a method for preparing an antioxidant and/or anticorrosion agent for lubricating oil comprising diphenylamine and phenyl-α-naphthylamine units.

Thus, there is a very urgent need in the state of the art to develop antioxidant, or even antiozonant additives, alternative to standard antioxidants as mentioned above for manufacturing more virtuous rubber compositions.

In particular, there is a need in the state of the art to develop alternative antioxidant additives for rubber composition having both a satisfactory antioxidant effect, while at the same time making it possible to increase the level of safety (reduced danger to humans) and reduce the environmental impact of the rubber composition in which the antioxidant is incorporated, in the targeted fields of application (automotive, clothing, etc.).

### DISCLOSURE OF THE INVENTION

In this context, the Applicant focused in developing compounds having both antioxidant properties, while preventing and/or reducing the toxicity of a rubber composition in which they are incorporated, compared to that of the standard antioxidants, such as those mentioned above, belonging in particular to the diphenylamine (DPA) or p-phenylenediamine (PPD) monomer family. For example, CN 107 540 559 describes that the compound 4,4′-bis(α,α-dimethylbenzyl)diphenylamine, which is a diphenylamine monomer (DPA), would be toxic. As mentioned above, this effect is by no means demonstrated by this disclosure. However, the toxicity QSAR test carried out by the Applicant proves, on the contrary, that this compound is toxic, whether in terms of reprotoxicity, mutagenicity and/or carcinogenicity.

As it will be illustrated in the experimental part below, the Applicant has in particular surprisingly and unexpectedly demonstrated that once oligomerized and/or polymerized, the toxicity of diphenylamine monomers is drastically reduced. Thus, they make it possible to form oligomers and/or polymers comprising at least one diphenylamine repeat unit having both antioxidant, or even antiozonant properties, suitable for various areas of use of rubber composition (tires, electric cables, etc.), while being less, or not toxic at all to humans and/or environment.

Indeed, the experimental tests below show that the antioxidants according to the invention, which have been selected by the Applicant, were not chosen arbitrarily and have a technical effect different (namely, they reduce/prevent/avoid the toxicity of a rubber composition) from other antioxidant compounds, in particular to diphenylamine (DPA) or p-phenylenediamine (PPD) monomers.

Although the use of oligomer and/or polymer compounds comprising at least one diphenylamine repeat unit as antioxidant additives has already been considered in the prior art especially in order to form antioxidants for lubricant compositions which are by definition liquid, to the knowledge of the Applicant, no study has demonstrated that they are non-toxic and therefore useful for preventing and/or reducing, or even avoiding the toxicity and even less so in a rubber composition that is solid and cross-linked.

It was indeed unexpected and unsuspected that oligomers/polymers (i.e. macromolecules) could have an antioxidant effect similar to that of monomers or substances, which are by definition theoretically more mobile and more active in solid rubber compositions. It is important to distinguish between a solid and cross-linked material and a fluid through which it is easier to get a soluble antioxidant to work. To date, to the knowledge of the Applicant, the high-performance technical benchmark for antioxidant in rubber compositions (tire) is the compound disclosed in CN 107 540 559, namely 4,4′-bis(α,α-dimethylbenzyl)diphenylamine (CAS 10081-67-1 for the product Naugard® 445). However, as mentioned above, this compound is toxic, unlike the compounds of the invention. The other substances commonly used in this field are 6PPD (comparative compound 22) and IPPD (comparative compound 23). These two compounds are also toxic, one of them is even a CMR compound in accordance with applicable European regulations. Thus, the particular technical effect of the compounds according to the invention could not be predicted from the teachings of the prior art.

In addition, the Applicant considers that testing for toxicity of antioxidants is not a measure that is obvious to the ordinary skilled in the art. This is why the Applicant developed an effective, in-depth methodology based on four models (C: carcinogenic, M: mutagenic, R: reprotoxic and N: neurotoxic) in order to indisputably test the toxicity of a compound globally. In particular, this methodology highlighted the greatly reduced toxicity of the oligomers/polymers of diphenylamines according to the invention compared with other conventional antioxidant compounds. To date, in line with the increasingly stringent requirements of applicable regulations (like the European Chemicals Agency (ECHA), etc.) the classification of many antioxidants are evolving, generally in the wrong direction. For example, the product Irganox L57 (described in Table 1 below) has also just been classified as a CMR compound.

In conclusion, a combination of high technical performance and high antioxidant capacity (at the level of the highest standards in the field, such as Naugard 445) combined with a greatly reduced overall toxicity could only be very non-trivial, even unlikely for the person skilled in the art.

### SUMMARY OF THE INVENTION

Thus, the present invention relates to the use of at least one antioxidant in a rubber composition, said at least one antioxidant comprising at least one oligomer and/or polymer comprising at least one diphenylamine repeat unit of the general formula (I):

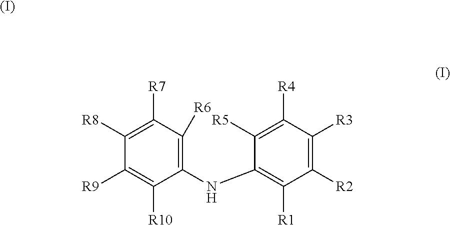

wherein each of R1 to R10 is independently selected from a hydrogen atom, an alkyl group which is a saturated, linear or branched hydrocarbon group comprising from 1 to 24 carbon atoms and an aralkyl group which is an alkyl group as described above of which at least one of the carbon atoms is substituted by a hydrocarbon aromatic monocyclic or polycyclic aryl group comprising 5 to 14 carbon atoms, for reducing and/or preventing the toxicity of said rubber composition.

Of course, the different characteristics, variants and embodiments of the invention can be combined with each other according to various combinations insofar as they are not incompatible or mutually exclusive.

In the present invention, unless otherwise specified, the term “comprise” and its derivatives are to be understood as non-limiting and do not exclude the presence of other components or steps. In some particular embodiments, the term “comprise” may be understood as “consists essentially of” or “consists of”.

Unless otherwise specified, the intervals mentioned in the present invention are inclusive of limits.

### DETAILED DESCRIPTION

The present invention thus relates to the use of at least one antioxidant in a rubber composition, said at least one antioxidant comprising at least one oligomer and/or polymer comprising at least one diphenylamine repeat unit of the general formula (I):

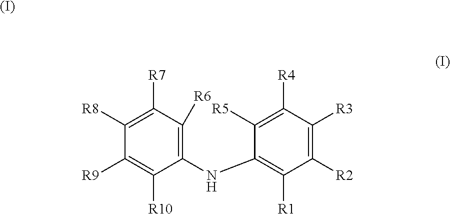

wherein each of R1 to R10 is independently selected from:
a hydrogen atom,
an alkyl group which is a saturated, linear or branched hydrocarbon group comprising from 1 to 24 carbon atoms and
an aralkyl group which is an alkyl group as described above of which at least one of the carbon atoms is substituted by a hydrocarbon aromatic monocyclic or polycyclic aryl group comprising 5 to 14 carbon atoms,
for reducing and/or preventing the toxicity of said rubber-based composition in which it is incorporated from that of antioxidants belonging to the family of diphenylamine (DPA) or p-phenylenediamine (PPD) monomers.

By antioxidant, we mean specialty chemical additives used to interrupt the oxidation-related degradation process in compositions in which they are incorporated, in the present case, rubber compositions.

According to the invention, by “toxicity” of a substance and/or a composition, we mean that said substance and/or said composition has at least one, preferably at least two, in particular, at least three and typically at least four, like at least five, at least six, or even all the following toxicities:
reprotoxicity corresponding to impaired fertility or impairment of the mammal/unborn living being,
mutagenicity which is the propensity of a substance to cause genetic mutations,
acute toxicity which is the induced toxicity, within a short period of time (eg. 24 h), by administering or contacting (topical application) a single dose (optionally massive) or several doses acquired in this period of time of a toxic product or mixture (natural or chemical),
ecotoxicity which is all the imbalances or nuisances caused by an industrial activity or the introduction of a foreign body or product into a natural environment, generally as a result of human activity;
neurotoxicity which is the ability of a substance or a compound to induce harmful effects in the nervous system of a mammal/living being, such as humans or planarians,
carcinogenicity which is the propensity of a substance to cause/trigger the development of cancer or contribute to its worsening,
toxicity on the synthesis, degradation, transport and mode of action of hormones, as is the case of endocrine disruptors (indirect toxicity via the physiological changes they cause).

A compound having a CMR nature (carcinogenic, mutagenic or toxic to reproduction) thereby presents various toxicity.

According to a characteristic of the invention, toxicity thus includes one or more of the following toxicities: neurotoxicity, reprotoxicity, mutagenicity, acute toxicity, carcinogenicity, toxicity on the synthesis, degradation, transport and mode of action of hormones, and ecotoxicity.

By “reduce” the toxicity of a rubber composition, we mean that said at least antioxidant according to the invention (i.e. including at least one oligomer and/or polymer comprising at least one diphenylamine repeat unit of the general formula (I)) is capable of and/or configured to decrease the toxicity of a rubber composition in which it is included, namely by its presence, particularly in relation to other generally toxic possible standard antioxidant compounds, that said at least antioxidant according to the invention comprising at least one oligomer and/or polymer comprising at least one diphenylamine repeat unit of the general formula (I) lowers/reduces the toxicity of a rubber composition and provides a non-toxic rubber composition or at least with reduced toxicity.

By “to prevent” the toxicity of a rubber composition, we mean said at least antioxidant according to the invention comprising at least one oligomer and/or polymer comprising at least one diphenylamine repeat unit of the general formula (I) prevents the rubber composition from being considered toxic and/or prevents the appearance of toxic symptoms in a mammal or any other living being, such as a human or an animal, which comes into contact with said rubber composition. As an example, neurotoxic symptoms can for example affect the central nervous system (CNS) and have the following effects: headaches, loss of appetite, drowsiness, mood and personality disorders, cognitive impairment (learning and concentration difficulties), or affect the peripheral nervous system (SNP) and have the following effects: motor impairments such as weakness, tremors, incoordination, convulsions, etc. or sensory impairments such as reduced hearing, color vision, tinnitus, loss of balance, etc.; these effects may or may not be reversible, depending on the degree of acute or chronic exposure of the mammal. As an example, acute toxicity symptoms may be skin irritations, allergic skin reaction, emesis, etc.

In general, said at least antioxidant according to the invention (i.e. comprising at least one oligomer and/or polymer comprising at least one diphenylamine repeat unit of the general formula (I)) is capable of and/or configured to reduce and/or prevent the toxicity of a rubber composition at the various stages in the life of said rubber composition, i.e. its implementation, its use and its end-of-life, including spreading in the environment (such as particles, or wear of a tire made from said composition).

According to a particular embodiment, said oligomer and/or polymer comprising at least one diphenylamine repeat unit of the general formula (I) may also comprise at least one phenyl α-naphthylamine repeat unit of the general formula (II):

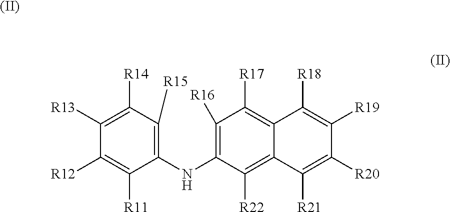

wherein each of R11 to R22 is independently selected from:
a hydrogen atom and
an alkyl group which is a saturated, linear or branched hydrocarbon group comprising from 1 to 24 carbon atoms.

A “polymer” of at least one diphenylamine and optionally at least one phenyl α-naphthylamine refers in the present invention to a compound comprising the repeat of at least two diphenylamine units with optionally at least one phenyl α-naphthylamine unit.

An “oligomer” of at least one diphenylamine and optionally at least one phenyl α-naphthylamine refers in the present invention to a polymer of at least one diphenylamine and optionally at least one phenyl α-naphthylamine that comprises between 2 and 15 repeat units, or a mixture of such compounds. This might include a dimer, trimer, tetramer, pentamer, hexamer, heptamer, octamer, nonamer, decamer and/or any mixture of such compounds. Preferably, the oligomer contains (in relative %) at least 70%, preferably 80% and in particular 90% by mass of dimer, trimer, tetramer, pentamer or of a mixture of such compounds. In general, the oligomer is a dimer and/or trimer.

A diphenylamine or phenyl α-naphthylamine “repeat unit” refers to the fact that, in the final structure of the oligomer or polymer obtained according to the invention, at least one diphenylamine unit and at least one phenyl α-naphthylamine unit, or at least two diphenylamine units with optionally at least one phenyl α-naphthylamine unit, are present.

The diphenylamine and phenyl α-naphthylamine repeat units can be positioned in any way in relation to each other in the polymer or oligomer structure according to the invention. Thus, the polymer or oligomer may include, at least on a part of its structure, a regular alternation of diphenylamine and phenyl α-naphthylamine repeat units. It may include, at least on a part of its structure, a randomized distribution of the diphenylamine and phenyl α-naphthylamine repeat units. It may finally include, on at least a part of its structure, a block comprising a single type of diphenylamine or phenyl α-naphthylamine repeat unit.

In an embodiment, the polymer and/or oligomer according to the invention contains only diphenylamine and phenyl α-naphthylamine repeat units in its structure. In another embodiment, the polymer and/or oligomer according to the invention contains only diphenylamine repeat units in its structure.

A “diphenylamine” refers to a compound of the formula (I):

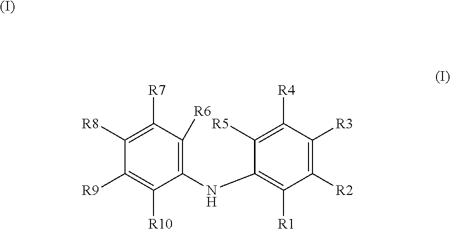

wherein each of R1 to R10 is independently selected from: a hydrogen atom, an alkyl group (which is a saturated, linear or branched hydrocarbon group comprising from 1 to 24 carbon atoms) and an aralkyl group (which is an alkyl group as described above of which at least one of the carbon atoms is substituted by a hydrocarbon aromatic monocyclic or polycyclic aryl group comprising 5 to 14 carbon atoms).

In an embodiment, the at least one diphenylamine of the formula (I) is an alkylated diphenylamine, which means that at least one of R1 to R10 is an alkyl or aralkyl group. In another embodiment, at least one of R1 to R5 is an alkyl or aralkyl group, and at least one of R6 to R10 is an alkyl or aralkyl group.

In general, each of R1 to R10 is independently selected from: a hydrogen atom or an alkyl group which is a saturated, linear or branched hydrocarbon group comprising from 1 to 24 carbon atoms, preferably comprising from 1 to 15 carbon atoms, in particular from 3 to 12 carbon atoms and typically from 3 to 10 carbon atoms. As an example, said at least three substituents can be independently from each other a tert-butyl group or a tert-octyl group or a n-nonyl group.

Generally, at least one, in particular at least two and typically at least three substituents from R1 to R10 is an alkyl group (such as defined hereafter), the other substituents being a hydrogen atom. Generally less than nine, in particular less than six and typically less than four of the substituents from R1 to R10 is an alkyl group, the other substituents being a hydrogen atom. According to the invention, “at least one” includes the following numbers and all the intervals between them: 1; 2; 3; 4; 5; 6; 7; 8; 9; 10. Also, in the context of the invention, “less than nine” includes the following numbers and all the intervals between them: 9; 8; 7; 6; 5; 4; 3; 2; 1. As an example, one or two substituents R1 to R10 is an alkyl group, the other substituents being a hydrogen atom.

An “alkyl” refers in the present invention to a saturated, linear, branched or cyclic hydrocarbon group comprising from 1 to 24 carbon atoms. Preferably, an alkyl group comprises from 1 to 12 carbon atoms. Thus, according to the invention, “an alkyl comprising 1 to 24 carbon atoms” includes the following carbon numbers and all the intervals between them: 1; 2; 3; 4; 5; 6; 7; 8; 9; 10; 11; 12; 13; 14; 15; 16; 17; 18; 19; 20; 21; 22; 23; 24. The alkyl groups include, in particular, methyl group, ethyl group, n-propyl group, iso-propyl group, n-butyl group, tert-butyl group, iso-butyl group, n-pentyl group, iso-pentyl group, n-hexyl group, cyclohexyl group, n-heptyl group, n-octyl group, tert-octyl group, iso-octyl group, n-nonyl group, n-decyl group, n-undecyl group, n-dodecyl group and iso-dodecyl group. In a particular embodiment, an alkyl group is selected from the group consisting of tert-butyl group and tert-octyl group, or n-nonyl group (nC9), and can be selected from the group consisting of tert-butyl group and tert-octyl group.

An “aralkyl” refers in the present invention to an alkyl group in which at least one carbon atom is substituted by an aryl group. Examples of aralkyl groups include the 1-methyl 1-phenylethyl group, a styryl (C₆H₅—CH═CH—) or methylstyryl moiety.

An “aryl group” refers in the present invention to a monocyclic or polycyclic aromatic hydrocarbon group. Each polyaromatic or aromatic cycle comprises 5 to 14 atoms. Examples of aryl groups include the phenyl group.

In an embodiment, the diphenylamine of the formula (I) is selected from the group consisting of the N,N-diphenylamine, N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine, N-(p-tert-butylphenyl)-N-(p-tert-octylphenyl)amine, tert-butylated and/or tert-octylated diphenylamines, nonylated diphenylamines, and any mixtures thereof.

In a particular embodiment, the polymer and oligomer according to the present invention comprise only diphenylamine units. The oligomer comprising at least one diphenylamine repeat unit of the general formula (I) according to the invention can thus be a dimer, trimer, tetramer, pentamer of one or more of these diphenylamines of the formula (I) described above and, as an example, is a dimer or trimer of di-(p-tert-octylphenyl)amine (DODPA).

In particular, when the oligomer comprising at least one diphenylamine repeat unit of the general formula (I) according to the invention is a dimer, it has at least three, in general at least four substituents from all the substituents R1 to R10 of the repeat unit of the formula (I) forming the dimer which are not a hydrogen atom (the other substituents are thus hydrogen atoms). According to the invention, “at least three substituents from R1 to R10 of the repeat unit of the formula (I) forming the dimer” comprises the following numbers: 3; 4; 5; 6; 7; 8; 9; 10; 11; 12; 13; 14; 15; 16; 17; 18; 19; 20 and may correspond for example to three or four substituents from all of the substituents R1 to R10 forming the dimer. In general, said at least three substituents are each preferably an alkyl group, i.e.: saturated, linear or branched hydrocarbon group comprising from 1 to 24 carbon atoms, preferably comprising from 3 to 15 carbon atoms, in particular from 5 to 12 carbon atoms and typically from 6 to 9 carbon atoms. As an example, said at least three substituents can be independently from each other a tert-butyl group or a tert-octyl group or even a n-nonyl group. Generally, said at least three substituents are independently distributed over the two diphenylamine repeat units of the formula (I) of the dimer. Typically, each repeat unit comprises at least one of said three substituents. As an example, a dimer repeat unit comprises at least one substituent from R1 to R10 which is not a hydrogen atom (and is preferentially an alkyl group such as defined above) and the other dimer unit comprises at least two substituents from R1 to R10 which is not a hydrogen atom (and is preferentially an alkyl group such as defined above).

In general, when the oligomer comprising at least one diphenylamine repeat unit of the general formula (I) according to the invention is a trimer, it has at least one, preferably at least two substituents from all of the substituents R1 to R10 of the repeat unit of the formula (I) forming the trimer, which is not a hydrogen atom (the other substituents are thus hydrogen atoms). According to the invention, “at least one substituent from all the substituents R1 to R10 of the repeat unit of the formula (I) forming the trimer” comprises the following numbers: 1; 2; 3; 4; 5; 6; 7; 8; 9; 10; 11; 12; 13; 14; 15; 16; 17; 18; 19; 20; 21; 22; 23; 24; 25; 26; 27; 28; 29; 30 and can correspond for example to five or six substituents from all of the substituents R1 to R10 forming the trimer. In particular, said at least one, preferably five, or even six substituents are each generally an alkyl group, i.e.: saturated, linear or branched hydrocarbon group comprising from 1 to 24 carbon atoms, preferably comprising from 3 to 15 carbon atoms, in particular, from 5 to 12 carbon atoms and typically from 6 to 9 carbon atoms. As an example, said substituent(s) can be independently from each other a tert-butyl group or a tert-octyl group or a n-nonyl group and typically is a tert-octyl group. Generally, said at least one, preferably five, or six substituents is/are independently distributed over the three diphenylamine repeat units of the formula (I) forming the trimer. Typically, each repeat unit of the trimer comprises at least one, or even two substituents from R1 to R10 which is an alkyl group such as defined above (the other substituents being hydrogen atoms). Generally, said alkyl substituent(s) are independently distributed over the three diphenylamine repeat units of the formula (I) of the trimer. Typically, each repeat unit of the trimer comprises at least one, or even two alkyl substituents (the other substituents being hydrogen atoms).

The diphenylamines according to the invention may be in isolated form or mixed together. For example, they can be in the form of a mixture of N,N-diphenylamine, N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine and N-(p-tert-butylphenyl)-N-(p-tert-octylphenyl)amine, the tert-butylated and/or tert-octylated diphenylamines, the nonylated diphenylamines.

The oligomers and/or polymers comprising at least one diphenylamine repeat unit of the general formula (I) may correspond to the compounds exemplified hereafter.

A phenyl α-naphthylamine refers according to the present invention to a compound of the formula (II):

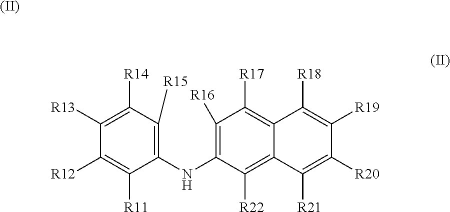

wherein each of R11 to R22 is independently selected from:
a hydrogen atom and
an alkyl group which is a saturated, linear or branched hydrocarbon group comprising from 1 to 24 carbon atoms.

In an embodiment, at least one from R11 to R22 is an alkyl group. In an embodiment, only one from R11 to R22 is an alkyl group, in particular a tert-octyl group.

In a particular embodiment, the phenyl α-naphthylamine is the N-(4-tert-octylphenyl)-1-naphthylamine, of the CAS 4572-51-4 number (OPAN).

In an embodiment of the invention, the at least one diphenylamine is in the form of a mixture of N,N-diphenylamine, N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine and N-(p-tert-butylphenyl)-N-(p-tert-octylphenyl)amine, and the at least one phenyl α-naphthylamine is the N-(4-tert-octylphenyl)-1-naphthylamine (OPAN).

In another embodiment of the invention, the at least one diphenylamine is the di-(p-tert-octylphenyl)amine (DODPA) and the at least one phenyl α-naphthylamine is the N-(4-tert-octylphenyl)-1-naphthylamine (OPAN). The oligomer forming the antioxidant according to the invention can thus be a trimer 2DODPA/1OPAN, 1DODPA/2OPAN, 3DODPA. According to an embodiment, said at least one oligomer can be a mixture of trimers, such as a mixture of 2DODPA/1OPAN, 1DODPA/2OPAN and 3DODPA. In particular, within this mixture, the oligomer 2DODPA/1OPAN is the majority. In general, said at least one oligomer comprises a mixture of trimers (such as 2DODPA/1OPAN, 1DODPA/2OPAN, 3DODPA), tetramers, pentamers and hexamers.

The relative proportions by mass of the two types of diphenylamine and phenyl α-naphthylamine units within the polymer or the oligomer may range to a large extent from 0/100 to 100/0. Preferably, the relative proportion by mass diphenylamine/phenyl α-naphthylamine is between 100/0 and 10/90, especially between 100/0 and 30/70 (such as 50/50 or 80/20), in particular between 100/0 and 90/10 and typically between 100/0 and 95/5.

The polymer or oligomer according to the present invention forming said at least antioxidant according to the invention may especially be prepared according to the method described in the patent application FR 2010199 filed by the Applicant company, i.e. in a continuous reactor. The ordinary skilled in the art is able to adjust the amounts of diphenylamine and phenyl α-naphthylamine to be introduced into the reactor depending in particular on the desired structure of the oligomer or polymer to be synthesized and the desired thermal characteristics. The polymer or oligomer according to the present invention forming said at least antioxidant according to the invention may especially also be prepared according to the method described in US 2019/0127526 or WO 2008/022028.

For the present invention, the Applicant has demonstrated the non-toxicity of said at least antioxidant comprising at least one oligomer and/or polymer comprising at least one diphenylamine repeat unit of the formula (I) and optionally at least one phenyl α-naphthylamine repeat unit of the formula (II) according to the invention by QSAR modelling tests for neurotoxicity, reprotoxicity, mutagenicity and carcinogenicity.

In particular, the oligomer and/or polymer comprising at least one diphenylamine repeat unit of the formula (I) and optionally at least one phenyl α-naphthylamine repeat unit of the formula (II) has a QSAR value for the measurement of each of the following toxicities: neurotoxicity (neurotoxic QSAR), reprotoxicity (reprotoxic QSAR), mutagenicity (mutagenic QSAR), and carcinogenicity (carcinogenic QSAR), corresponding to a statistical threshold value (%) subtracted from a delta of at least 30%, said statistical threshold value being determined, for each of said toxicities, by the QSAR (Quantitative Structure Activity Relationship) Modelling according to the method described hereafter in the experimental part.

According to the invention, “a delta of at least 30%” for the QSAR modelling includes the following values and the intervals between them: 30; 31; 32; 33; 34; 35; 36; 37; 38; 39; 40; 41; 42; 43; 44; 45; 46; 47; 48; 49; 50; 51; 52; 55; 60; 65; 70; 75; 80; 85; 90; 91; 92; 93; 94; 95; 96; 97; 98; 99; 100 (this range of at least 30% is to be adapted for each of the toxicities).

According to an embodiment, the statistical threshold value of the neurotoxic QSAR in percent is typically 55%.

Preferably, the delta for the neurotoxic QSAR measurement is at least 45%, advantageously at least 55% and typically at least 53%.

In general, the oligomer and/or polymer comprising at least one diphenylamine repeat unit of the formula (I) and optionally at least one phenyl α-naphthylamine repeat unit of the formula (II) has a percentage (%) value by QSAR modelling of less than or equal to 10%, preferably less than or equal to 5% and typically less than or equal to 2% for the neurotoxicity measurement (neurotoxic QSAR).

According to the invention, a value less than or equal to 10% for the neurotoxic QSAR modelling includes the following values and all the intervals between them: 10; 9; 8; 7; 6; 5; 4; 3; 2; 1; 0.9; 0.8; 0.70; 0.69; 0.68; 0.67; 0.66; 0.65; 0.64; 0.63; 0.62; 0.61; 0.60; 0.59; 0.058; 0.57; 0.56; 0.55; 0.54; 0.53; 0.52; 0.51; 0.50; 0.49; 0.48; 0.47; 0.46; 0.45; 0.44; 0.42; 0.40; 0.38; 0.36; 0.34; 0.32; 0.30; 0.28; 0.26; 0.24; 0.22; 0.20; 0.18; 0.16; 0.14; 0.12; 0.10; 0.09; 0.08; 0.07; 0.06; 0.05; 0.04; 0.03; 0.02; 0.01; 0.00.

According to another embodiment, the reprotoxic QSAR statistical threshold value in percent is typically 90%.

Preferably, the delta for the reprotoxic QSAR measurement is at least 41%, advantageously at least 43% and typically at least 46%.

In general, the oligomer and/or polymer comprising at least one diphenylamine repeat unit of the formula (I) and optionally at least one phenyl α-naphthylamine repeat unit of the formula (II) has a percentage (%) value by QSAR modelling of less than or equal to 65%, preferably less than or equal to 50% and typically less than or equal to 45% for the reprotoxicity measurement (reprotoxic QSAR).

According to the invention, a value of less than or equal to 65% for the reprotoxic QSAR modelling includes the following values and all the intervals between them: 65; 64; 63; 62; 61; 60; 59; 58; 57; 56; 55; 54; 53; 52; 51; 50; 49; 48; 47; 46; 45; 44; 43; 42; 41; 40; 39; 38; 37; 36; 35; 34; 33; 32; 31; 30; 29; 28; 27; 26; 25; 24; 23; 22; 21; 20; 15; 10; 5; 3; 1; 0.50; 0.49; 0.48; 0.47; 0.46; 0.45; 0.44; 0.42; 0.40; 0.38; 0.36; 0.34; 0.32; 0.30; 0.28; 0.26; 0.24; 0.22; 0.20; 0.18; 0.16; 0.14; 0.12; 0.10; 0.09; 0.08; 0.07; 0.06; 0.05; 0.04; 0.03; 0.01; 0.00.

According to another embodiment, the mutagenic QSAR statistical threshold value in percent is typically 58%.

Preferably, the delta for the mutagenic QSAR measurement is at least 48%, advantageously at least 53% and typically at least 56%.

In general, the oligomer and/or polymer comprising at least one diphenylamine repeat unit of the formula (I) and optionally at least one phenyl α-naphthylamine repeat unit of the formula (II) has a percentage (%) value by QSAR modelling of less than or equal to 10%, preferably less than or equal to 5% and typically less than or equal to 2% for the mutagenicity measurement (mutagenic QSAR).

According to the invention, a value of less than or equal to 10% for the mutagenic QSAR modelling includes the following values and all the intervals between them: 10; 9; 8; 7; 6; 5; 4; 3; 2; 1; 0.9; 0.8; 0.70; 0.69; 0.68; 0.67; 0.66; 0.65; 0.64; 0.63; 0.62; 0.61; 0.60; 0.59; 0.058; 0.57; 0.56; 0.55; 0.54; 0.53; 0.52; 0.51; 0.50; 0.49; 0.48; 0.47; 0.46; 0.45; 0.44; 0.42; 0.40; 0.38; 0.36; 0.34; 0.32; 0.30; 0.28; 0.26; 0.24; 0.22; 0.20; 0.18; 0.16; 0.14; 0.12; 0.10; 0.09; 0.08; 0.07; 0.06; 0.05; 0.04; 0.03; 0.02; 0.01; 0.00.

According to another embodiment, the carcinogenic QSAR statistical threshold value in percent is typically 85%.

Preferably, the delta for the carcinogenic QSAR measurement is at least 77%, advantageously at least 82% and typically at least 85%.

In general, the oligomer and/or polymer comprising at least one diphenylamine repeat unit of the formula (I) and optionally at least one phenyl α-naphthylamine repeat unit of the formula (II) has a percentage (%) value by QSAR modelling of less than or equal to 10%, preferably less than or equal to 5% and typically less than or equal to 2% for the carcinogenicity measurement (carcinogenic QSAR).

According to the invention, a value of less than or equal to 10% for the carcinogenic QSAR modelling includes the following values and all the intervals between them: 10; 9; 8; 7; 6; 5; 4; 3; 2; 1; 0.9; 0.8; 0.70; 0.69; 0.68; 0.67; 0.66; 0.65; 0.64; 0.63; 0.62; 0.61; 0.60; 0.59; 0.058; 0.57; 0.56; 0.55; 0.54; 0.53; 0.52; 0.51; 0.50; 0.49; 0.48; 0.47; 0.46; 0.45; 0.44; 0.42; 0.40; 0.38; 0.36; 0.34; 0.32; 0.30; 0.28; 0.26; 0.24; 0.22; 0.20; 0.18; 0.16; 0.14; 0.12; 0.10; 0.09; 0.08; 0.07; 0.06; 0.05; 0.04; 0.03; 0.02; 0.01; 0.00.

“Rubber composition” generally refers to an elastomer composition comprising by definition natural or synthetic macromolecular substances, having rubber-like elasticity. In particular, elastomer means a polymer having elastic properties, obtained by crosslinking.

“Rubber/elastomer” refers to an elastic, impervious and resistant substance obtained by coagulating the latex of certain plants, trees or lianas from equatorial forest, or synthetically prepared, by polymerizing various unsaturated hydrocarbons.

The common classification consists of dividing rubbers into three broad categories (the acronyms used are those recommended by the 1995 ISO 1629 standard):
general-purpose rubbers, represented by the natural rubber (NR) and synthetic polyisoprene (IR), butadiene styrene copolymers (SBR) and polybutadienes (BR);
special-purpose rubbers, which are the ethylene propylene and diene co- or terpolymers (EPM and EPDM), chlorinated or brominated isobutylene isoprene copolymers (IIR, BIIR, CIIR), butadiene acrylonitrile copolymers (NBR), and polychloroprenes (CR);
very special-purpose rubbers that bring together the silicone rubbers (VMQ, FVMQ), fluorinated elastomers (FKM), chlorinated or chlorosulfonated polyethylenes (CM, CSM), polyacrylates (ACM), ethylene vinyl acetate copolymers (EVM) and ethylene methyl acrylate (AEM), hydrogenated nitrile rubbers (HNBR) and epichlorohydrin rubbers (CO, ECO, GECO), kneadable polyurethanes (AU, EU).
   Thermoplastic elastomers which form a separate category can be added to this classification. In fact, compared to the previously mentioned rubbers, these elastomers do not need to be vulcanized and can be processed in the same way as the thermoplastics.

In a known way, natural rubber (NR) is produced by coagulating the latex from several plants, mainly from hevea, Hevea brasiliensis, Euphorbiaceae family, native to the Amazon. The latex is collected by incising the bark of the trunks so that it drains from the laticifer ducts into buckets placed just below. The harvested latex is transferred into containers, filtered and can then be stabilized with ammonia (precipitation of flakes) and then pressed to reduce its water content or coagulated in a more or less controlled way and dried by smoke from a fire (tars prevent putrefaction) in order to obtain rubber bullets.

As an example, synthetic rubber can be manufactured by polymerizing various monomers, including isoprene (2-methyl-1,3-butadiene), 1,3-butadiene, chloroprene (2-chloro-1,3-butadiene), and isobutylene (methylpropene) with a low percentage of isoprene for crosslinking. These monomers and others can be mixed in various desirable proportions to be copolymerized for a wide range of physical, mechanical and chemical properties. Monomers can be pure products and the addition of impurities and additives can be controlled by design to provide optimum properties. The polymerization of pure monomers can be better controlled to give a desired ratio of cis and trans double bonds. Other rubber compositions are well known such as butadiene-acrylonitrile, also kwon as “nitrile butadiene rubber” (NBR) or ethylene acrylic rubber (AEM).

In the present invention, rubber composition or elastomer composition (synonym) means a composition comprising mostly rubber, namely a composition comprising, by mass, at least 60%, preferably at least 70%, in particular at least 80% and typically at least 90% rubber.

Generally, said rubber composition and/or said at least antioxidant additive does not substantially comprise, preferably does not comprise, diphenylamine monomers (DPA) or p-phenylenediamines (PPD) or any other standard antioxidant (toxic and/or ecotoxic) mentioned above in the description of the prior art. In some embodiments, the rubber composition used according to the invention or the antioxidant agent used according to the invention does not substantially comprise, preferably does not comprise, an antioxidant additive other than the oligomer and/or polymer comprising at least one diphenylamine repeat unit of the formula (I) and optionally at least one phenyl α-naphthylamine repeat unit of the formula (II) according to the invention.

In general, the antioxidant additive according to the invention represents, by mass, based on the total mass of the antioxidant agents in the rubber-based composition, from 50% to 100%, preferably from 80% to 100%, and in particular from 90% to 100%, and typically 100%. According to the invention, by “50% to 100%” we mean the following values or any interval between them: 50; 55; 60; 65; 70; 75; 80; 85; 90; 95; 100.

Said at least antioxidant agent and generally said at least oligomer and/or polymer comprising at least one diphenylamine repeat unit of the formula (I) and optionally at least one phenyl α-naphthylamine repeat unit of the formula (II) is present in the rubber-based composition used in the present invention in an amount such as those conventionally used in the art. For example, they can be used in an amount of from 0.1 to 10% by weight, preferably 0.5 to 5% by weight, typically from 1 to 4% based on the total weight of said rubber composition.

The rubber composition may also comprise other additives, such as mineral solid fillers to enhance the mechanical properties, carbon black, plasticizers, vulcanizing agents (such as elemental sulphur or polythiols), vulcanization accelerators, crosslinking retardants, silanes and other agents capable of increasing the crosslinking degree, etc. These other additives will not be described in more detail below because their composition and conditions of use (mass content, etc.) are known to the ordinary skilled in the art depending on the intended uses of the rubber-based composition.

The present invention can also be applied to a method for preserving physicochemical and mechanical properties of a rubber-based composition comprising:
prepare said rubber composition, which preferably does not comprise diphenylamine (DPA) monomers or p-phenylenediamines (PPD),
incorporate in said rubber-based composition an effective amount of at least one antioxidant comprising an oligomer and/or polymer comprising at least one diphenylamine repeat unit of the formula (I) such as defined above and optionally at least one phenyl α-naphthylamine repeat unit of the formula (II) such as defined above,
   said at least antioxidant being capable of reducing and/or preventing the toxicity of said rubber-based composition.

Of course, the various embodiments described above for the use of said at least antioxidant to prevent and/or reduce the toxicity of a rubber-based composition also apply to this method and will not be repeated hereafter.

According to the invention, unless otherwise stated, the percentages indicated in the present application are percentages by mass.

In the present invention, the term “about” a value V refers to an interval between 0.9×V and 1.1×V. In some embodiments, it refers to an interval between 0.95×V and 1.05×V, in particular an interval between 0.99×V and 1.01×V.

### EXAMPLES

### Example 1: Toxicity Study

Les oligomers and/or polymers comprising at least one diphenylamine repeat unit of the formula (I) and optionally at least one phenyl α-naphthylamine repeat unit of the formula (II) according to the invention were studied and compared to other standard antioxidant compounds in terms of QSAR modelling for the neurotoxicity, reprotoxicity, mutagenicity and carcinogenicity.

### QSAR Modelling Protocol

The toxicity degrees of various compounds used according to the invention and other standard antioxidants s were evaluated by QSAR modelling (Quantitative Structure/Activity Relationship).

### Selection of Training and Validation Sets

An assembly of test molecules was defined with chemical structures compiled from several publicly available sources such as: HSBD (Hazardous Substances Data Bank), EPA (U.S. Environmental Protection Agency), ECHA (European Chemicals Agency) and NTP (National Toxicology Program). About 34,000 molecules were selected for this project including: 3245 compounds classified as neurotoxic compounds, 12609 compounds classified as reprotoxic compounds, 4084 compounds classified as mutagenic compounds, 12158 compounds classified as carcinogenic compounds and 1953 compounds, called non-toxic, classified as neither neurotoxic nor reprotoxic nor mutagenic nor carcinogenic.

Based on this assembly of test molecules, two sets of molecules were defined: one training set and one validation set. To do this, the “leave one out” method was used. The assembly of test molecules was divided into two sets, one containing 90% of the test molecules and forming the training set and the other containing the 10% remaining test molecules and forming the validation set.

### Performance of the QSAR Model

A method of generalized linear model (GLM) was selected to carry out a quantitative structure/activity relationship (QSAR) approach. Based on the training set, the GLM models were separately trained for discriminating the chemical structures (i) between neurotoxic and non-neurotoxic compounds, (ii) between reprotoxic and non-reprotoxic compounds, (iii) between mutagenic and non-mutagenic compounds and (iv) between carcinogenic and non-carcinogenic compounds. This approach resulted in four GLM models with respectively 328, 313, 327 and 330 significant descriptors within the neurotoxic, reprotoxic, mutagenic and carcinogenic training sets. During the training, the performance of the QSAR models was measured by ROC (Receiver Operator Characteristic) curves and resulted in area under the curve (AUC) values of 0.8831 for the neurotoxicity prediction, 0.7967 for the reprotoxicity prediction, 0.8444 for the mutagenicity prediction and 0.8333 for the carcinogenicity prediction.

To validate the robustness of the QSAR models, they were then used for predicting (i) the neurotoxicity categories of the validation set compounds (i.e. neurotoxic/non-neurotoxic categorization), (ii) the reprotoxicity categories of the validation set compounds (i.e. reprotoxic/non-reprotoxic categorization), (iii) the mutagenicity categories of the validation set compounds (i.e. mutagenic and non-mutagenic categorization) and (iv) the carcinogenicity categories of the validation set compounds (i.e. carcinogenic and non-carcinogenic categorization). During the validation, the performance of the QSAR models was measured by area under the curve (AUC) values and provided significant values of 0.76 and more for the prediction of the neurotoxicity, mutagenicity and carcinogenicity and provided significant values of 0.70 for the prediction of the reprotoxicity.

The GLM-based QSAR models were then used for studying the compounds according to the invention.

### Result Interpretation

Once the model was constructed on the training set, and then validated with the validation set, the latter mathematically determines on a statistical basis a statistical threshold value in percent.

QSAR statistical threshold values for the various toxicities tested are illustrated in Table 2 below:

TABLE 2

| | Non-toxic and moderately | Toxic |
|---|---|---|
| | toxic molecules | molecules |
| | (%) | (%) |
| Neurotoxic QSAR | <55% | ≥55% |
| Reprotoxic QSAR | <90% | ≥90% |
| Mutagenic QSAR | <58% | ≥58% |
| Carcinogenic QSAR | <85% | ≥85% |

This statistical threshold is an initial outline for distinguishing non-toxic, moderately toxic molecules and toxic molecules. However, it does not allow toxic molecules to be totally excluded from non-toxic molecules, i.e. the margin of error on the probability of the risk of toxicity). The Applicant thus refined his research and determined that a reduction of the statistical threshold of a delta by 30% for each model (neurotoxic QSAR, reprotoxic QSAR, etc.) provided a reliable guarantee that the molecules tested are toxic or non-toxic. Indeed, this new threshold (statistical threshold-30%) indisputably separates moderately toxic and residual toxic molecules from non-toxic molecules. Also, an intermediate range (non-zero probability of toxicity) including moderately toxic and/or toxic molecules was established in order to establish a more precise classification.

The classification refined by the Applicant is showed in Table 3 below.

TABLE 3

| | Slightly | Moderately toxic | |
|---|---|---|---|
| | toxic | (intermediate range) | Highly toxic |
| | (%) | (%) | (%) |
| Neurotoxic QSAR | <25 | 25 ≤ QSAR < 55 | 55 ≤ QSAR ≤ 100 |
| Reprotoxic QSAR | <60 | 60 ≤ QSAR < 90 | 90 ≤ QSAR ≤ 100 |
| Mutagenic QSAR | <28 | 28 ≤ QSAR < 58 | 58 ≤ QSAR ≤ 100 |
| Carcinogenic QSAR | <55 | 55 ≤ QSAR < 85 | 85 ≤ QSAR ≤ 100 |

The compounds tested are numbered as follows (Table 4 below):

TABLE 4

| | | CAS | |
|---|---|---|---|
| Ex | Chemical name | No | Structural formula |
| A | p,p′′-dioctyldiphenylamine dimer or DODPA dimer | 35972- 72-6 | 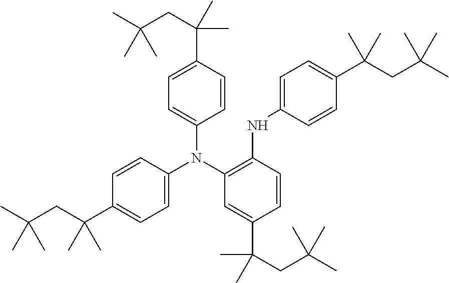 [SMILES: CC(C)(C)CC(C)(C)c1ccc(Nc2ccc(C(C)(C)CC(C)(C)C)cc2N(c2ccc(C(C)(C)CC(C)(C)C)cc2)c2ccc(C(C)(C)CC(C)(C)C)cc2)cc1] |
| B | Trimer: 2DODPA / 1 OPAN | — | 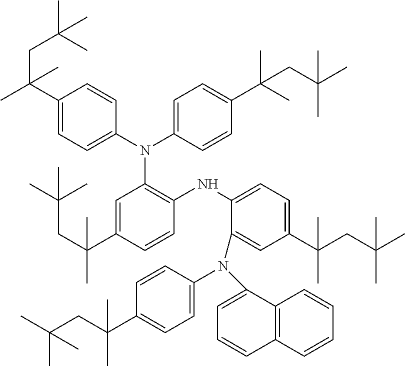 [SMILES: CC(C)(C)CC(C)(C)c1ccc(N(c2ccc(C(C)(C)CC(C)(C)C)cc2)c2cc(C(C)(C)CC(C)(C)C)ccc2Nc2ccc(C(C)(C)CC(C)(C)C)cc2N(c2ccc(C(C)(C)CC(C)(C)C)cc2)c2cccc3ccccc23)cc1] |
| C | DODPA and OPAN-based aminic | — | — |
| | oligomeric mixture (i.e.: of which 0-5% | | |
| | monomer, 25-30% dimer A, 20-25% | | |
| | trimer B, 15-20% tetramer) obtained | | |
| | according to the method described in the | | |
| | patent applications FR 2 924 122 and | | |
| | WO 2009/071857 | | |
| D | 4-Nonyl-n-(4-nonylphenyl)aniline dimer or [di(nC9)DPA]₂ | | 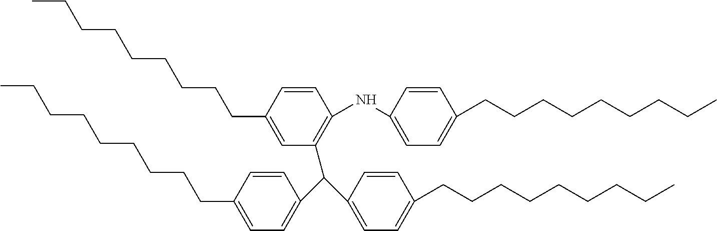 [SMILES: CCCCCCCCCc1ccc(Nc2ccc(CCCCCCCCC)cc2C(c2ccc(CCCCCCCCC)cc2)c2ccc(CCCCCCCCC)cc2)cc1] |
| E | (H, isoC8 DPA)/(isoC4, isoC8 DPA) | | 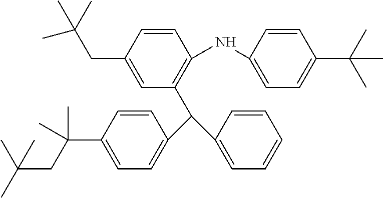 [SMILES: CC(C)(C)Cc1ccc(Nc2ccc(C(C)(C)C)cc2)c(C(c2ccccc2)c2ccc(C(C)(C)CC(C)(C)C)cc2)c1] |
| F | (isoC4, isoC8 DPA)₂ | | 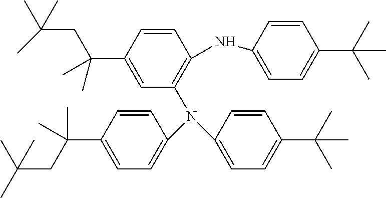 [SMILES: CC(C)(C)CC(C)(C)c1ccc(N(c2ccc(C(C)(C)C)cc2)c2cc(C(C)(C)CC(C)(C)C)ccc2Nc2ccc(C(C)(C)C)cc2)cc1] |
| G | (DODPA)(OPAN) | | 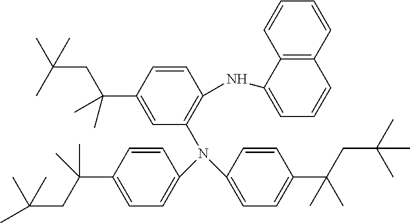 [SMILES: CC(C)(C)CC(C)(C)c1ccc(N(c2ccc(C(C)(C)CC(C)(C)C)cc2)c2cc(C(C)(C)CC(C)(C)C)ccc2Nc2cccc3ccccc23)cc1] |
| H | (H, isoC8 DPA)(isoC4, icoC8 DPA)(di- isoC8 DPA) | | 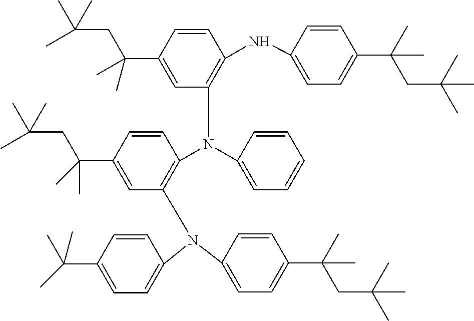 [SMILES: CC(C)(C)CC(C)(C)c1ccc(Nc2ccc(C(C)(C)CC(C)(C)C)cc2N(c2ccccc2)c2ccc(C(C)(C)CC(C)(C)C)cc2N(c2ccc(C(C)(C)C)cc2)c2ccc(C(C)(C)CC(C)(C)C)cc2)cc1] |
| I | (DODPA)₃ | | 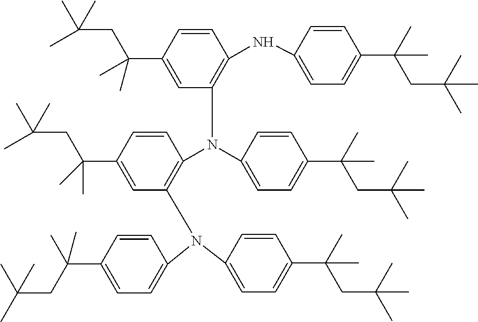 [SMILES: CC(C)(C)CC(C)(C)c1ccc(Nc2ccc(C(C)(C)CC(C)(C)C)cc2N(c2ccc(C(C)(C)CC(C)(C)C)cc2)c2ccc(C(C)(C)CC(C)(C)C)cc2N(c2ccc(C(C)(C)CC(C)(C)C)cc2)c2ccc(C(C)(C)CC(C)(C)C)cc2)cc1] |
| 1 | p,p′-dioctyldiphenylamine (DODPA) | 15721- 78-5 | 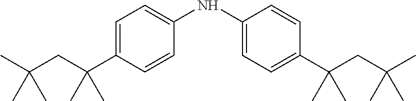 [SMILES: CC(C)(C)CC(C)(C)c1ccc(Nc2ccc(C(C)(C)CC(C)(C)C)cc2)cc1] |
| 2 | N-(4-tert-octylphenyl)-1-naphthylamine (OPAN) | 4572- 51-4 | 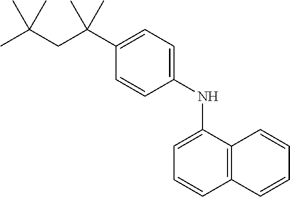 [SMILES: CC(C)(C)CC(C)(C)c1ccc(Nc2cccc3ccccc23)cc1] |
| 3 | 4,4′-Methylene-bis-(2,6-di-tert- butylphenol) (MEDBP) | 118- 82-1 | 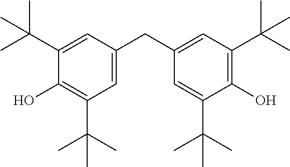 [SMILES: CC(C)(C)c1cc(Cc2cc(C(C)(C)C)c(O)c(C(C)(C)C)c2)cc(C(C)(C)C)c1O] |
| 4 | Octadecyl 3-(3,5-di-tert-butyl-4- hydroxyphenyl)propanoate Irganox® L107 | 2082- 79-3 | 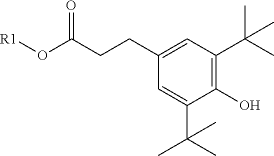 |
| | | | R1 = nC₁₈H₃₇ |
| 5 | Octyl 3-[4-hydroxy-3,5-bis(2-methyl-2- propanyl)phenyl]propanoate | 12564 3-61-0 | 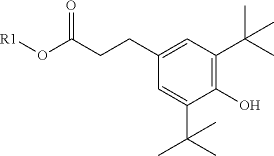 |
| | | | R1 = nC₈H₁₇ |
| 6 | 2-ethylhexyl 3-[4-hydroxy-3,5-bis(2- methyl-2-propanyl)phenyl]propanoate Irganox® L145 | 14442 9-84-5 | R1= 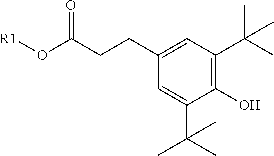 |
| | | | 2Ethylhexyl |
| 7 | 1,6-Hexanediyl bis{3-[4-hydroxy-3,5- bis(2-methyl-2- propanyl)phenyl]propanoate Irganox® L 109 | 35074- 77-2 | 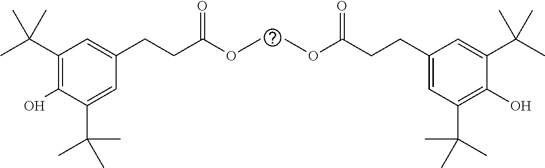 |
| 8 | 2-[(2-{[3-(3,5-di-tert-butyl-4- hydroxyphenyl)propanoyl]oxy}ethyl) sulfanyl]ethyl 3-(3,5-di-tert-butyl-4- hydroxyphenyl)propanoate Irganox® L115 | 41484- 35-9 | 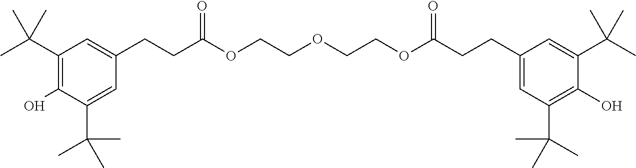 [SMILES: CC(C)(C)c1cc(CCC(=O)OCCOCCOC(=O)CCc2cc(C(C)(C)C)c(O)c(C(C)(C)C)c2)cc(C(C)(C)C)c1O] |
| 9 | 4-tertbutyldiphenylamine as a component of Irganox® L57 (68411- 46-1) | 4496- 49-5 | 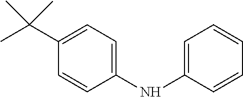 [SMILES: CC(C)(C)c1ccc(Nc2ccccc2)cc1] |
| 10 | Biphenyl-4-ylamine | 92-67-1 | 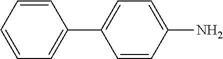 [SMILES: Nc1ccc(-c2ccccc2)cc1] |
| 11 | Nonylphenol | 25154- 52-3 | 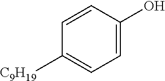 |
| | | | Position isomer mixture |
| 12 | 4-methylbenzene-1,3-diamine | 95-80-7 | 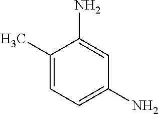 |
| 13 | 2-(2H-benzotriazol-2-yl)-4,6- ditertpentylphenol | 25973- 55-1 | 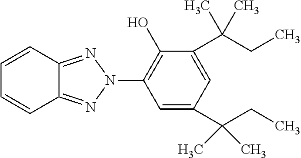 [SMILES: CCC(C)(C)c1cc(-n2nc3ccccc3n2)c(O)c(C(C)(C)CC)c1] |
| 14 | 4-tert-butylphenol | 98-54-4 | 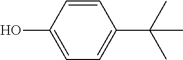 |
| 15 | 3,3-bis(4-hydroxyphenyl)-1,3-dihydro-2- benzofuran-1-one | 77-09-8 | 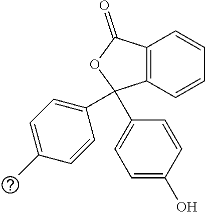 [SMILES: Cc1ccc(C2(c3ccc(O)cc3)OC(=O)c3ccccc32)cc1] |
| 16 | 2,4-dinitrotoluene | 121- 14-2 | 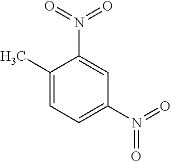 |
| 17 | 4-[(4-aminophenyl)methyl]aniline (MDA) | 101- 77-9 | 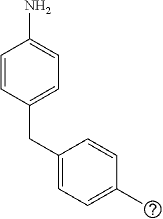 |
| 18 | N-phenylaniline (″Diphenylamine″ DPA) | 122- 39-4 | 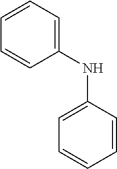 [SMILES: c1ccc(Nc2ccccc2)cc1] |
| 19 | N-phenylnaphthalene-1-amine (PAN (alpha)) | 90-30-2 | 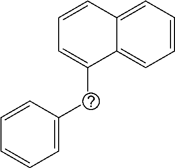 [SMILES: c1ccc(Cc2cccc3ccccc23)cc1] |
| 20 | N-phenylnaphthalene-2-amine (PAN (beta)) | 135- 88-6 | 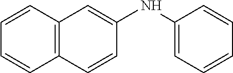 [SMILES: c1ccc(Nc2ccc3ccccc3c2)cc1] |
| 21 | 2-tert-butyl-6-[(3-tert-butyl-2-hydroxy-5- methylphenyl)methyl]-4-methylphenol | 119- 47-1 | 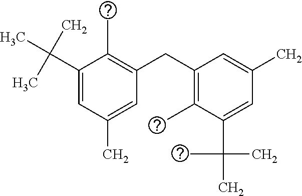 [SMILES: Cc1cc(Cc2cc(C)cc(C(C)(C)C)c2C)c(C)c(C(C)(C)C)c1] |
| 22 | N-(1,3-Dimethylbutyl)-N′-phenyl-p- phenylenediamine (6PPD) | 793- 24-8 | 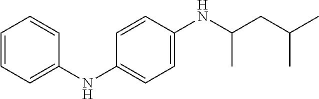 [SMILES: CC(C)CC(C)Nc1ccc(Nc2ccccc2)cc1] |
| 23 | N-Isopropyl-N′-phenyl-p- phenylenediamine (IPPD) | 101- 72-4 | 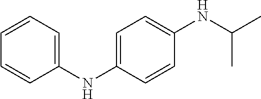 [SMILES: CC(C)Nc1ccc(Nc2ccccc2)cc1] |
| 24 | N,N′-Bis(1,4-dimethylpentyl)-P- phenylenediamine (77PD) | 3081- 14-9 | 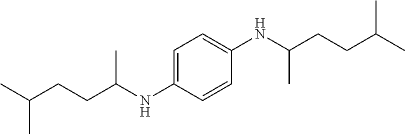 [SMILES: CC(C)CCC(C)Nc1ccc(NC(C)CCC(C)C)cc1] |
| 25 | Bis[4-(2-phenyl-2-propyl)phenyl]amine (NAUGARD® 445) | 10081- 67-1 | 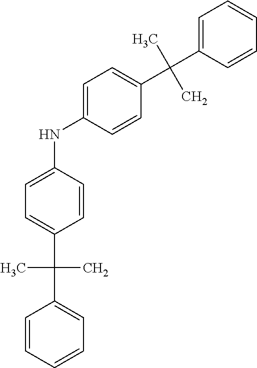 [SMILES: CC(C)(c1ccccc1)c1ccc(Nc2ccc(C(C)(C)c3ccccc3)cc2)cc1] |
| 26 | 4-Nonyl-n-(4-nonylphenyl)aniline | 24925- 59-5 | 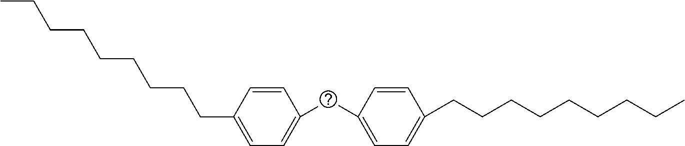 [SMILES: CCCCCCCCCc1ccc(Cc2ccc(CCCCCCCCC)cc2)cc1] |

Thus, examples named A to I are according to the invention and examples named 1 to 26 are comparative examples (standard antioxidants and antiozonants).

The results of the QSAR modelling are shown in Table 5 below:

TABLE 5

| | Carcinogenic | Mutagenic | Reprotoxic | Neurotoxic |
|---|---|---|---|---|
| Ex. | QSAR | QSAR | QSAR | QSAR |
| A | 0.0 | 0.0 | 32.4 | 0.5 |
| B | 0.4 | 0.1 | 44.6 | 0.0 |
| D | 0.2 | 0.0 | 6.9 | 0.2 |
| E | 11.7 | 0.0 | 53.6 | 0.0 |
| F | 4.0 | 0.0 | 32.7 | 0.0 |
| G | 6.6 | 0.0 | 37.5 | 0.0 |
| H | 0.1 | 0.0 | 1.3 | 0.0 |
| I | 0.2 | 0.0 | 0.0 | NA |
| 1 | 64.1 | 8.0 | 60.0 | 0.4 |
| 2 | 86.0 | 31.6 | 83.5 | 6.0 |
| 3 | 72.9 | 0.2 | 60.0 | 2.4 |
| 4 | 84.2 | 3.1 | 74.9 | 0.5 |
| 5 | 83.3 | 5.5 | 76.4 | 2.9 |
| 6 | 85.6 | 3.5 | 76.7 | 5.4 |
| 7 | 74.7 | 0.3 | 67.3 | 0.0 |
| 8 | 69.5 | 0.3 | 76.4 | 0.0 |
| 9 | 78.0 | 19.4 | 84.1 | 30.0 |
| 10 | 93.1 | 84.7 | 94.0 | 83.3 |
| 11 | 91.8 | 28.5 | 93.2 | 37.2 |
| 12 | 99.6 | 96.7 | 99.4 | 93.0 |
| 13 | 96.0 | 40.1 | 85.9 | 8.1 |
| 14 | 95.5 | 71.4 | 89.0 | 73.2 |
| 15 | 86.2 | 13.9 | 83.3 | 3.3 |
| 16 | 99.1 | 93.6 | 94.0 | 43.9 |
| 17 | 98.7 | 93.5 | 98.5 | 70.1 |
| 18 | 95.5 | 79.7 | 95.5 | 95.7 |
| 19 | 92.4 | 73.3 | 88.1 | 70.8 |
| 20 | 90.6 | 78.2 | 88.5 | 59.9 |
| 21 | 85.8 | 5.0 | 76.4 | 9.1 |
| 22 | 77.3 | 21.1 | 78.8 | 8.8 |
| 23 | 87.3 | 40.4 | 88.2 | 11.2 |
| 24 | 90.2 | 38.2 | 91.0 | 17.2 |
| 25 | 63.6 | 55.6 | 83.5 | 11.0 |
| 26 | 34.8 | 4.1 | 72.8 | 8.7 |

As shown in Table 5 above, the antioxidants comprising an oligomer and/or polymer comprising at least one diphenylamine repeat unit and optionally at least one phenyl α-naphthylamine repeat unit according to the invention have both a very low neurotoxicity, reprotoxicity, mutagenicity and a low carcinogenicity. In the contrary, the compounds that make up the standard antiozonant antioxidants are in general highly toxic, whether in terms of neurotoxicity, reprotoxicity, mutagenicity and/or carcinogenicity.

This QSAR modelling test therefore demonstrates that the oligomers and/or polymers comprising at least one diphenylamine repeat unit and optionally at least one phenyl α-naphthylamine repeat unit according to the invention prevent and/or reduce the toxicity of a rubber-based composition.

### Toxicity Assessment Protocol Using In Vivo Tests

In order to complete the QSAR modelling tests, the Applicant carried out in vivo tests on so-called planarian models, invertebrate microorganisms living in water and having a cephalic sphere and an apparent neuronal system, used in the literature to assess the neurotoxicity, the neurodevelopment and the reprotoxicity of compounds of concern such as pesticides and other toxic organophosphorus compounds (Poirier et al., Médecine/Sciences (Paris) 2019; 35 (6-7): 544-8 “Le planaire, un modèle animal original pour la toxicologie”; Collins et al. US2020209223-A1; D. Hagstrom et al., Archives of toxicology, 2017 91 (8), 2837-2847; Zhang et al., TOXICOLOGICAL SCIENCES, 2018, 1-19; Ireland et al., Chemosphere, 2020, 253, 126718). The tests were carried out under conditions similar to those reported in the publication mentioned above (Zhang et al., TOXICOLOGICAL SCIENCES, 2018, 1-19).

The operating conditions used are as follows:
Test concentration number per chemical product: 5
Concentration range: 0.22 mg/L-22 mg/L in semi-logarithmic steps
Organism studied: whole adult planarians
Test time: 12 days with an assessment of control points at 7 and 12 days
Control points: lethality, adhesion (production of sticky mucus by the skin, leading the planarian to stick to a wall rather than float), speed of movement, rest (proportion of rest time to time spent moving), phototaxis and “scrunching” (specific mode of movement nominally used by the planarian in the event of danger, in this case excessive heat).
Number of replicas: 3

The methodology used is described hereafter:
all the compounds are provides as a powder;
a suitable volume of DMSO 100% (Sigma) was added as shown on the tubes to obtain 200 times broth at 4.4 mg/ml;
screening was carried out in triplicate plates, by following the same plate assembly procedure as described in Zhang et al., Neurotoxicology and Teratology, 2019.

TABLE 6

| | | | Concentration above | |
|---|---|---|---|---|
| | Concentration above | | which significant | |
| | which behavioral problems | | mortality of planarian is | |
| | potentially linked to | | observed according to Zhang | |
| | cognitive problems in the | | et al., Neurotoxicology | |
| Ex. | planarian are observed** | | and Teratology, 2019 | |
| C (Table 4) | >22 | mg/L | >22 | mg/L |
| 19 | 2.2-3.9 | mg/L | 6.9 | mg/L |
| 22 | 1.5 | mg/L | 4.8 | mg/L |

**Registered behavioral problems: adhesion (production of sticky mucus by the skin, leading the planarian to stick to a wall rather than float), speed of movement, rest (proportion of rest time to time spent moving), phototaxis and “scrunching” (specific mode of movement nominally used by the planarian in the event of danger, in this case excessive heat).

This test shows that the antioxidants according to the invention (compound A and B mixture) have no toxicity in vivo, particularly in comparison with the comparative antioxidants PAN alpha and 6PPD.

### Example 2: Antioxidant Performances of Oligomer and/or Polymer Compounds Used According to the Invention

### Formulations Tested:

For this test, two types of rubber were prepared and assessed: HNBR rubber which is a hydrogenated butadiene-acrylonitrile rubber and AEM rubber (VAMAC®) which is an acrylic ethylene rubber.

For each rubber, three formulations were carried out varying only the antioxidant which is:
either a standard antioxidant of the prior art, namely Bis[4-(2-phenyl-2-propyl)phenyl]amine, CAS 10081-67-1 (corresponding to the commercial product Naugard 445®, high-performance and high-temperature benchmark for rubber additives),
or a mixture of this standard antioxidant with an antioxidant according to the invention corresponding to the Example C in Table 4,
or the antioxidant according to the invention (Example C).

HNBR-type rubbers are formulated according to the composition summarized in Table 7 hereafter (proportions are indicated in phe: parts per hundred parts of elastomer):

TABLE 7

| | | Comp. | | |
|---|---|---|---|---|
| Compounds | Name/Supplier | 1 | F1 | F2 |
| Rubber | HNBR ZETPROL ® 2000 | 100 | 100 | 100 |
| | from Zeon | | | |
| Carbon black | N772 | 60 | 60 | 60 |
| Plasticizer | TOTM oil (Trioctyl | 10 | 10 | 10 |
| | trimellitate | | | |
| Antioxidant (high- | Naugard 445 ® | 4 | 2 | 0 |
| temperature market | | | | |
| performance) | | | | |
| Antioxidant | Example C (invention) | 0 | 2 | 4 |
| Vulcanization | Active ZnO | 3 | 3 | 3 |
| catalyst | | | | |
| Vulcanization | Stearic acid | 1 | 1 | 1 |
| accelerator | | | | |
| Cross-linking agent | Sulphur | 0.5 | 0.5 | 0.5 |
| Primary | MBT 100 | 0.5 | 0.5 | 0.5 |
| vulcanization | (Mercaptobenzothiazol) | | | |
| accelerator | | | | |
| Secondary | TBzTD (Tetrabenzyl | 3 | 3 | 3 |
| vulcanization | thiuram disulfide) | | | |
| accelerator | | | | |

AEM-type rubbers are formulated according to the composition summarized in Table 8 hereafter (proportions are indicated in phe: parts per hundred parts of elastomer):

TABLE 8

| | | Comp. | | |
|---|---|---|---|---|
| Compounds | Name/Supplier | 2 | F3 | F4 |
| Rubber | VAMAC ULTRA LS | 100 | 100 | 100 |
| Carbon black | N660 | 70 | 70 | 70 |
| | Alcanplast PO80 | 15 | 15 | 15 |
| Antioxidant (prior art, | Naugard 445 ® | 4 | 2 | 0 |
| high-temperature | | | | |
| market performance) | | | | |
| Antioxidant (invention) | Example C (invention) | 0 | 2 | 4 |
| Vulcanization | Stearic acid | 1 | 1 | 1 |
| accelerator | | | | |
| Dispersing agent | Armeen 18 D | 1 | 1 | 1 |
| Hexamethylene | DIAK 1 | 1.5 | 1.5 | 1.5 |
| diamine carbamate | | | | |
| (accelerator) | | | | |
| Amine on silica | Vulcofact ACT 55 | 2 | 2 | 2 |
| (accelerator) | | | | |

The six mixtures (i.e. without the vulcanization system) were formulated in a 300 cm³ HAAKE internal mixer, and then an acceleration system was added to a cylinder mixer. A rheometric test was carried out at 180° C. for each mixture. 150*150*2 mm HNBR-type rubber plates were compression molded after 98 min at 180° C. 150*150*2 mm EAM-type rubber plates were molded after 98 min at 180° C., then post-vulcanized in an oven at 150° C. for 4 h.

### Results

The mechanical properties of these six formulations were assessed in the initial state (Table 9) and after ageing for 10 days at 130° C. (Table 10) and the results are as follows:

TABLE 9
Initial state

| Properties | Comp. 1 | F1 | F2 | Comp. 2 | F3 | F4 |
|---|---|---|---|---|---|---|
| Density (g/cm³) | 1.16 | 1.16 | 1.16 | 1.26 | 1.26 | 1.26 |
| (NF ISO 2781) | | | | | | |
| Shore hardness A | 54 | 56 | 58 | 71 | 70 | 70 |
| (NF ISO 7619-1) | | | | | | |
| Max stress (MPa) | 10.1 | 11.0 | 10.5 | 17.4 | 16.2 | 17.0 |
| (NF ISO 37) | | | | | | |
| Elongation at max. stress | 1130 | 1070 | 1050 | 284 | 284 | 297 |
| (%) (NF ISO 37) | | | | | | |
| C100% (MPa) | 1.32 | 1.35 | 1.40 | 5.6 | 5.6 | 4.7 |
| (NF ISO 6502) | | | | | | |
| C300% (MPa) | 2.38 | 2.56 | 2.81 | / | / | / |
| (NF ISO 6502) | | | | | | |
| C300/C100 | 1.80 | 1.90 | 2.00 | / | / | / |

TABLE 10
After ageing for 10 days at 130° C.

| Properties | Comp. 1 | F1 | F2 | Comp. 2 | F3 | F4 |
|---|---|---|---|---|---|---|
| Density (g/cm³) | 1.17 | 1.17 | 1.17 | 1.278 | 1.277 | 1.275 |
| (NF ISO 2781) | | | | | | |
| Shore hardness A | 62 | 63 | 65 | 73 | 72 | 74 |
| (NF ISO 7619-1) | | | | | | |
| Max stress (MPa) | 9.8 | 9.9 | 9.7 | 16.9 | 15.8 | 16.6 |
| (NF ISO 37) | | | | | | |
| Elongation at max. stress | 759 | 782 | 782 | 277 | 261 | 283 |
| (%) (NF ISO 37) | | | | | | |
| C100% (MPa) | 2.13 | 2.09 | 2.00 | 5.4 | 5.9 | 5.0 |
| (NF ISO 6502) | | | | | | |
| C300% (MPa) | 5.83 | 5.73 | 5.51 | / | / | / |
| (NF ISO 6502) | | | | | | |
| C300/C100 | 2.74 | 2.74 | 2.76 | / | / | / |

Thus, this test shows that the levels of mechanical performance and ageing for rubber compositions obtained with the antioxidant additive according to the invention are at the same, or even higher, level compared to the same compositions made from a comparative antioxidant recognized in the market (high performance and high temperature market benchmark), for two different rubber compositions (i.e.: HNBR and AEM).

Of course, various other modifications can be made to the invention within the scope of the appended claims.

1-10. (canceled)

11. A method for reducing and/or preventing the toxicity of a rubber composition, said method comprising:
incorporating into the rubber composition at least one antioxidant, said at least one antioxidant comprising at least one oligomer and/or polymer comprising at least one diphenylamine repeating unit of the formula (I) 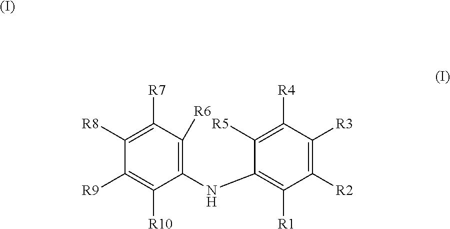
wherein each of R1 to R10 is independently selected from
a hydrogen atom,
an alkyl group which is a saturated, linear or branched hydrocarbon group comprising from 1 to 24 carbon atoms and
an aralkyl group which is an alkyl group as described above of which at least one of the carbon atoms is substituted by a hydrocarbon aromatic monocyclic or polycyclic aryl group comprising 5 to 14 carbon atoms,

12. The method according to claim 11, wherein the toxicity comprises one or more of the following toxicities: neurotoxicity, reprotoxicity, mutagenicity, acute toxicity, carcinogenicity, toxicity on the synthesis, degradation and mode of action of hormones, and ecotoxicity.

13. The method according to 11, wherein said oligomer and/or polymer also comprises at least one phenyl α-naphthylamine repeating unit of the general formula (II): 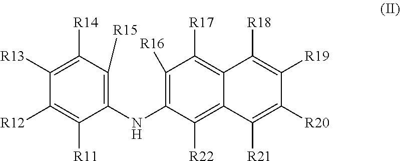
wherein each of R11 to R22 is independently selected from a hydrogen atom and an alkyl group which is a saturated, linear or branched hydrocarbon group comprising from 1 to 24 carbon atoms.

14. The method according to claim 11, wherein the at least one diphenylamine of the formula (I) is an alkylated diphenylamine wherein at least one of R1 to R10 is an alkyl or aralkyl group.

15. The method according to claim 14, wherein the at least one diphenylamine of the formula (I) is an alkylated diphenylamine wherein at least two of R1 to R10 is an alkyl or aralkyl group.

16. The method according to claim 14, wherein the at least one diphenylamine of the formula (I) is an alkylated diphenylamine wherein at least one of R1 to R10 is an alkyl or aralkyl group selected from tert-butyl group or a tert-octyl group and a n-nonyl group.

17. The method according to claim 16, wherein the at least one diphenylamine of the formula (I) is an alkylated diphenylamine wherein at least one of R1 to R10 is an alkyl or aralkyl group selected from a tert-butyl group or a tert-octyl group.

18. The method according to claim 11, wherein the diphenylamine of the formula (I) is selected from the group consisting of N,N-diphenylamine, N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine, N-(p-tert-butylphenyl)-N-(p-tert-octylphenyl)amine, tert-butylated and/or tert-octylated diphenylamines, nonylated diphenylamines and any mixture thereof.

19. The method according to claim 13, wherein said oligomer and/or polymer comprising at least one diphenylamine repeating unit is selected from one or more of the following compounds: di-t-octyl-diphenylamine dimer, di-t-octyl-diphenylamine trimer, trimer comprising two di-t-octyl-diphenylamine units and one N-(4-tert-octylphenyl)-1-naphthylamine unit, and oligomer of the mixture N,N-diphenylamine, N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine, N-(p-tert-butylphenyl)-N-(p-tert-octylphenyl)amine.

20. The method according to claim 13, wherein the phenyl α-naphthylamine is the N-(4-tert-octylphenyl)-1-naphthylamine.

21. The method according to 11, wherein the polymer and/or oligomer comprises in its structure only diphenylamine repeating units.

22. The method according to claim 13, wherein the polymer and/or oligomer comprises in its structure only diphenylamine repeating units and phenyl α-naphthylamine repeating units.

23. The method according to claim 11, wherein the oligomer and/or polymer comprising at least one diphenylamine repeating unit of the formula (I) has a QSAR value for the measurement of each of the following toxicities: neurotoxicity (neurotoxic QSAR), reprotoxicity (reprotoxic QSAR), mutagenicity (mutagenic QSAR), and carcinogenicity (carcinogenic QSAR), corresponding to a statistical threshold value (%) subtracted from a delta of at least 30%, said statistical threshold value being determined, for each of said toxicities, by the QSAR Modelling according to the method described in the experimental part.

24. The method according to claim 13, wherein the oligomer and/or polymer comprising at least one diphenylamine repeating unit of the formula (I) and at least one phenyl α-naphthylamine repeating unit of the formula (II) has a QSAR value for the measurement of each of the following toxicities: neurotoxicity (neurotoxic QSAR), reprotoxicity (reprotoxic QSAR), mutagenicity (mutagenic QSAR), and carcinogenicity (carcinogenic QSAR), corresponding to a statistical threshold value (%) subtracted from a delta of at least 30%, said statistical threshold value being determined, for each of said toxicities, by the QSAR Modelling according to the method described in the experimental part.
